(19) United States
(12) Patent Application Publication
(10) Pub. No.: US 2015/0274300 A1
(43) Pub. Date: Oct. 1, 2015

(54) BEVERAGE HOLDER

(71) Applicant: Karl Anthony Moore, Yakima, WA (US)

(72) Inventor: Karl Anthony Moore, Yakima, WA (US)

(21) Appl. No.: 14/672,171

(22) Filed: Mar. 28, 2015

Related U.S. Application Data
(60) Provisional application No. 61/972,037, filed on Mar. 28, 2014.

(51) Int. Cl. B64D 11/06; F16M 13/02

(52) U.S. Cl. CPC B64D 11/0638; F16M 13/022

(57) ABSTRACT

A beverage holder that withstands jostling or inflight turbulence when used in an aircraft. The beverage holder includes a base frame with a U-shaped member on a lower portion of the base frame, a ring pivotably mounted to an upper portion of the base frame, and a support member and a grip member both pivotably mounted to the lower portion of the base frame. As preferred, a user orients the ring, the support member and the grip member such that a beverage cup is secured within the ring and the support member, and the grip member contacts the aircraft tray, which alternatively may be any type of table or tray.

### CROSS-REFERENCE TO RELATED APPLICATION

This Non-Provisional Utility Patent Application claims the benefit of U.S. Provisional Application No. 61/972,037, filed Mar. 28, 2014.

### TECHNICAL FIELD

The embodiments herein relate generally to beverage holders. More specifically, embodiments of the invention relate to a beverage holder especially suitable for use on an aircraft.

### BACKGROUND OF THE INVENTION

Passengers on commercial aircraft often spill their beverages due to inflight turbulence, other passengers reclining their seats, rowdy children, errant hands, or the like. Commercial aircraft do not provide the passenger with an adequate means to secure or hold a beverage. The aircraft seat tray table provides a small circular indentation to place a beverage cup. This is ineffective because the beverage cup often slides on the table and/or topples over, which spills the beverage out of the cup.

Alternatively, the seat pouch in front of each passenger is impractical because placing a cup in the pouch results in the pouch crushing the cup and/or beverage spills. Further, the seat pouch often does not have room for a beverage cup because it is filled with magazines, flight safety instructions, or the like.

As such, there is a need in the industry for an effective and easy-to-use aircraft beverage holder that can withstand inflight turbulence and other disturbances. The present invention addresses these problems and provides the needed compact, easy-to-use and practical beverage holder, especially suited for use by passengers on commercial carriers, such as aircraft, and as well as watercraft and ground transportation. The following is a disclosure of the present invention that will be understood by reference to the following detailed description taken in conjunction with the accompanying drawings.

### BRIEF DESCRIPTION OF DRAWINGS

FIG. 1 is an isometric view of a beverage holder, as including a beverage cup and attached to a tray, according to an embodiment of the invention;

FIG. 2 is an elevation view of a beverage holder, according to an embodiment of the invention;

FIG. 3 is an end view of a beverage holder, according to an embodiment of the invention;

FIG. 4 is a side view of a beverage holder, according to an embodiment of the invention;

FIG. 5 is an isometric view of a beverage holder, according to an embodiment of the invention;

FIG. 6 is an elevation view of a U-shaped member of a beverage holder, according to an embodiment of the invention;

FIG. 7 is an end view of a U-shaped member of a beverage holder, according to an embodiment of the invention;

FIG. 8 is a side view of a U-shaped member of a beverage holder, according to an embodiment of the invention.

FIG. 9 is an isometric view of a U-shaped member of a beverage holder, according to an embodiment of the invention;

FIG. 10 is a side view of a wire cable portion of a beverage holder, according to an embodiment of the invention;

FIG. 11 is an elevation view of a wire cable portion of a beverage holder, according to an embodiment of the invention;

FIG. 12 is a side view of a ring for a beverage holder, according to an embodiment of the invention.

FIG. 13 is an isometric view of a ring for a beverage holder, according to an embodiment of the invention;

FIG. 14 is a side view of a ring for a beverage holder, according to an embodiment of the invention;

FIG. 15 is an elevation view of a ring for a beverage holder, according to an embodiment of the invention;

FIG. 16 is a sectioned side view of a ring portion for a beverage holder taken along section line 16-16 of FIG. 15, according to an embodiment of the invention.

FIG. 17 is a side view of a ring portion for a beverage holder, according to an embodiment of the invention.

FIG. 18 is an isometric view of a ring portion for a beverage holder, according to an embodiment of the invention;

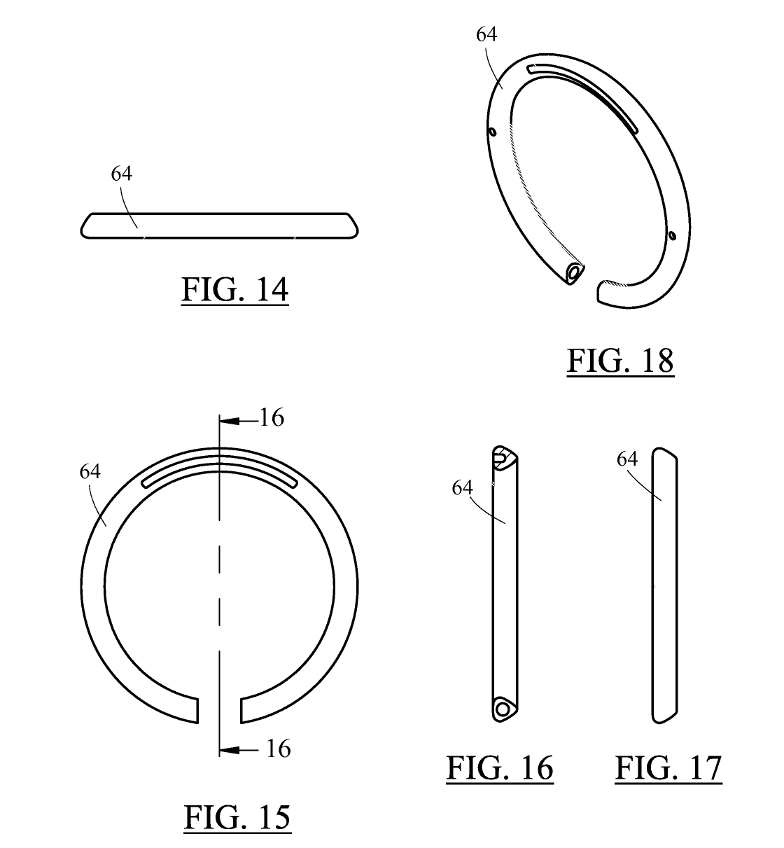

FIG. 14 is a side view of a ring for a beverage holder, according to an embodiment of the invention;

FIG. 19 is a first elevation view of an upper portion of a support member for a beverage holder, according to an embodiment of the invention;

FIG. 20 is a sectioned side view of an upper portion of a support member for a beverage holder taken along section line 20-20 of FIG. 19, according to an embodiment of the invention.

FIG. 21 is an end view of an upper portion of a support member for a beverage holder, according to an embodiment of the invention.

FIG. 22 is a side view of an upper portion of a support member for a beverage holder, according to an embodiment of the invention.

FIG. 23 is a second elevation view of an upper portion of a support member for a beverage holder, according to an embodiment of the invention.

FIG. 24 is an isometric view of an upper portion of a support member for a beverage holder, according to an embodiment of the invention;

FIG. 25 is an elevation view of a support member and a grip member for a beverage holder, according to an embodiment of the invention;

FIG. 26 is a sectioned side view of a support member and a grip member for a beverage holder taken along section line 26-26 of FIG. 25, according to an embodiment of the invention.

FIG. 27 is an end view of a support member and a grip member for a beverage holder, according to an embodiment of the invention.

FIG. 28 is a side view of a support member and a grip member for a beverage holder, according to an embodiment of the invention.

FIG. 29 is an isometric view of a support member and a grip member for a beverage holder, according to an embodiment of the invention;

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

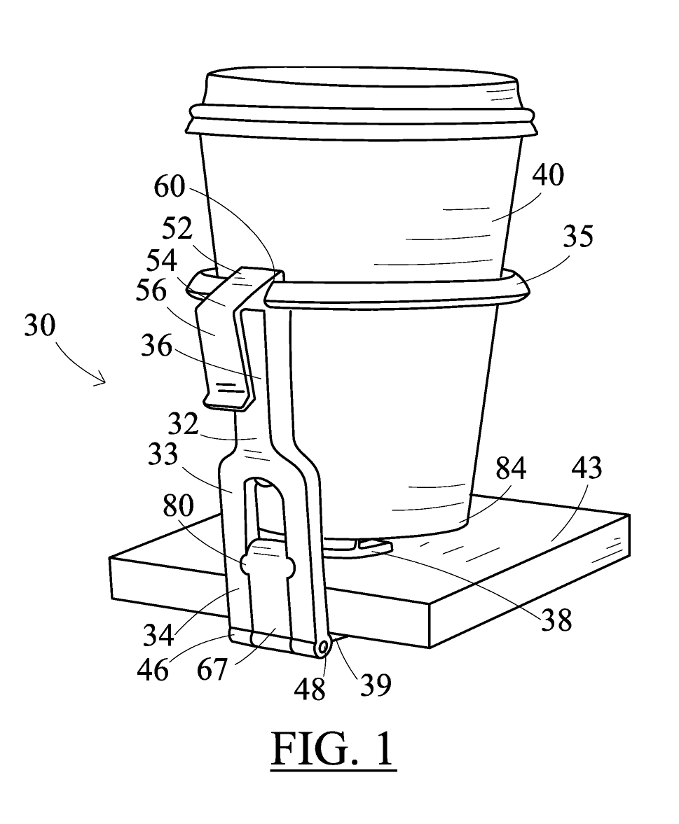

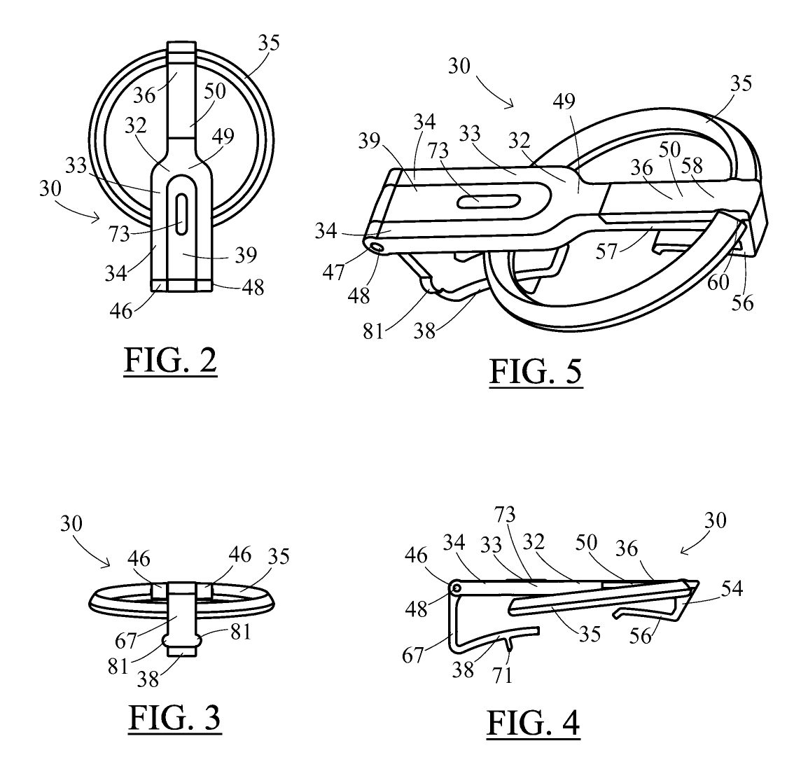

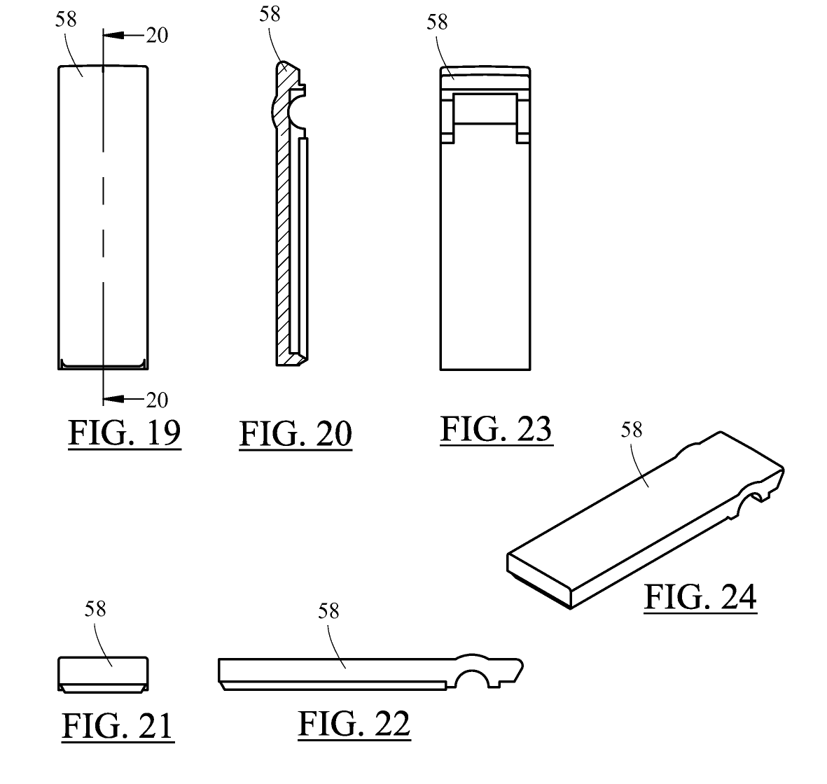

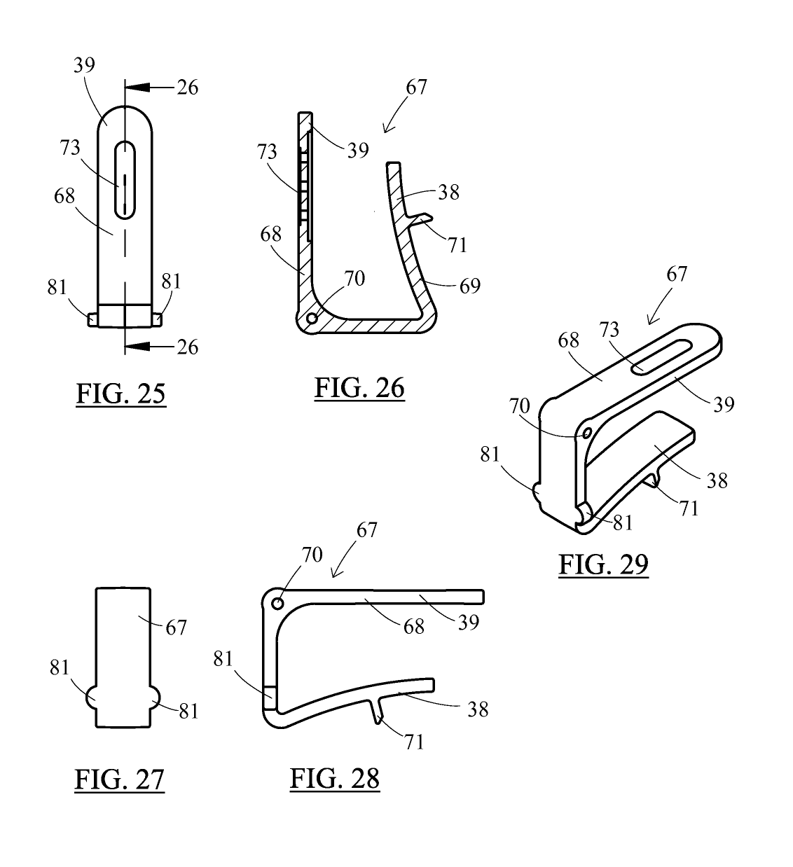

The present invention is a beverage holder device that is especially suited for use by passengers of commercial aircraft. In a preferred embodiment, as shown in FIGS. 1 through 29, the beverage holder 30 is an aircraft beverage holder is-configured to withstand inflight turbulence. The beverage holder comprises a base frame 32 comprising a U-shaped member 33 on a lower portion 34 of the base frame, a ring 35 pivotably mounted to an upper portion 36 of the base frame, and a support member 38 and a grip member 39 both pivotably mounted to the lower portion of the base frame, wherein a user orients the ring, the support member and the grip member such that a beverage cup 40 is secured within the ring and the support member, and the grip member is in contact with an aircraft tray 43.

In certain embodiments of the invention, the aircraft beverage holder 31 comprises the base frame 32 comprising he U-shaped member 33 on the lower portion 34 of the base frame, with the ring pivotably mounted to the upper portion 36 of the base frame, and the support 38 member 39 and the grip member both pivotably mounted to the lower portion of the base frame.

For the certain embodiment as preferred, the lower portion 34 of the base frame 32 is approximately a 99.746 mm long by approximately 6.773 mm high by approximately 29.017 mm wide U-shaped member 33. At the end of each “U” 46 in the U-shaped member, there are holes 47 for a mounting pin 48. The upper part of the “U” 49 has a single extension 50, which forms a tuning fork shape. The upper portion 36 of the base frame is a rectangular piece 52 approximately 46.902 mm high by approximately 4.375 mm thick by approximately 14 mm wide. A back clip 54 with an angled hook 56 may be affixed to the rectangular piece such that the upper portion of the base frame can hang onto an aircraft seat pocket (not shown). The back clip has dimensions of approximately 45.988 mm high by approximately 14 mm wide. An over mold may be disposed over the back clip.

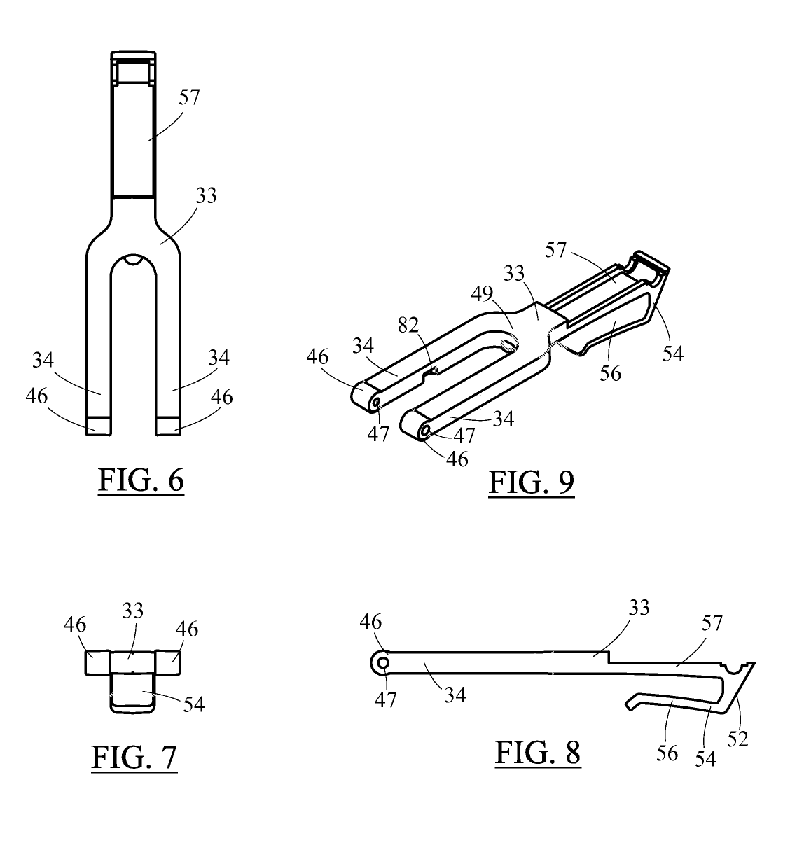

In a most preferred embodiment, the upper 36 and lower portions 34 of the base frame 32 are connected together as one piece. In an alternative embodiment, the upper and lower portions of the base frame can be two separate pieces connected by a spring (not shown) configured to adjust the overall height of the base frame. The upper portion of the base frame has a semi-circular opening 60 to receive the ring 35. As most preferred, to accommodate receiving the ring into the base frame, the upper portion of the base frame is a two-part assembly, including an upper portion frame 57 and an upper portion clasp 58. The base frame without the upper portion clasp is shown in FIGS. 6 through 9, and the upper portion clasp is shown in FIGS. 19 through 22.

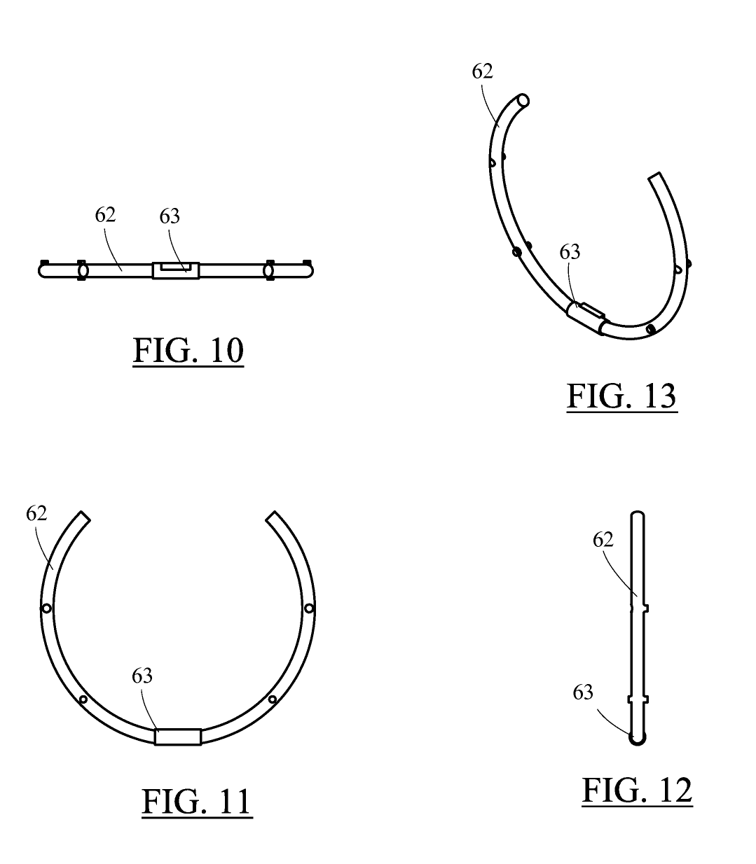

The ring 35 comprises a wire cable ring 62 that has an approximately 40.560 mm internal radius and 86.120 mm external diameter. It is approximately 2.5 mm thick with a slender section 63 measuring 2.2 mm thick and 14.4 mm long, which will fit into the upper portion 36 of the base frame 32. The wire cable ring 62 of the ring is shown in FIGS. 10 through 13.

Preferably, a silicone member 64 embeds the wire cable ring 62 and has approximately a 38.154 mm internal radius, approximately a 45.524 mm external radius and is approximately 6.685 mm in width. In a most preferred embodiment of the ring 35, the silicone member comprises a rounded triangular shape. The silicone member of the ring is shown in FIGS. 14 through 18. The silicone member is open at the ends to expose a portion of the wire cable ring that is pivotably mounted to the semi-circular opening 60 in the upper portion 36 of the base frame 32.

The support member 38 and grip member 39 together form a single member 67 that resembles a squared off J-shaped clamp, as preferred and shown in FIGS. 25 through 29. The J-shaped single member measures approximately 57.45 mm at the long side of the “J” 68, and approximately 6.979 mm wide. The single member has a short protrusion 71 from the short side of the “J” 69 and also includes a hole 70 measuring 2.5 mm in diameter through the bottom of the long “J” side. The J-shaped single member further comprises a rectangular silicon filled cutout 73 measuring approximately 30.910 mm with rounded ends, sunken approximately 0.945 mm on the outside facing long “J” side 74. The member further comprises two holes 76 within the cutout, with their centers measuring approximately 17.389 mm apart.

Preferably, the overall “J” shape member 67 is flat on the long side 68, slightly arched upward on the bottom and arched slightly inward on the short side of the “J” 69. The J-shaped support member 38 and grip member 39 are pivotably mounted to the U-shaped member 33 of the base frame 32 and configured to rotate approximately 90 degrees. A locking mechanism 80 may be used to secure the support member and grip member to the U-shaped member. For example, the J-shaped member may have tabs 81 that engage with indentations 82 on the U-shaped member.

Of note, the term “approximately” is employed herein throughout, including this detailed description and the attached claims, with the understanding that it denotes a level of exactitude or equivalence in amount or location commensurate with the skill and precision typical for the particular field of endeavor, as applicable.

In operation, a user adjusts the support member 38 and the grip member 39 such that the grip member rests on the aircraft tray 43. The user adjusts the ring 35 to a desired position. A beverage cup 40 is placed through the ring such that the bottom 84 of the cup rests on the support member 38. The beverage cup is now stable and can withstand inflight turbulence or other disturbances.

The beverage holder 30 of the present invention provides a compact, easy-to-use and practical holder for the beverage cup 40, especially suited for use by passengers on any commercial carrier, such as aircraft, and as well as watercraft and ground transportation. Since the above referred to “aircraft tray” 43 may be any tray, table, shelf or equivalent structure. Therefore, the beverage holder of the present invention is expected or is found to be useful to support and prevent the contents of the beverage cup from spilling in any conveyance, including automobiles, busses, trucks, trams, trains or boats. Additionally, the tray, table or shelf may be stationary, and not within a mobile conveyance, in even with a stationary tray, the beverage holder can serve to prevent contents of the beverage cup from spilling, or from a toppling of the beverage cup, with an unintended jostling or knocking against the beverage cup. The grip member 39 still serves to contact the tray and engage the tray between the support member 38 and the grip member.

Alternatively, the user can hang the beverage holder 30 in the seat pocket of an aircraft seat, or any other equivalent seat pocket structure, by using the upper portion 36 of the base member and the back clip 54. The user adjusts the ring, support member 38 and grip member 39 in the same manner described above to accommodate the beverage cup 40. To store the beverage holder, the user folds the ring, support member and grip member flat along the base frame 32.

It shall be appreciated that the components of the beverage holder 30 described in several embodiments herein may comprise any known materials in the field and be of any color, size and/or dimensions. For example, the components can be made from high grade industrial plastic, metal, silicone, or the like. It shall be appreciated that the components of the beverage holder described herein may be manufactured and assembled using any known techniques in the field.

Furthermore, persons of ordinary skill in the art may appreciate that numerous design configurations may be possible to enjoy the functional benefits of the inventive shown and described herein. Thus, given the wide variety of configurations and arrangements of embodiments of the present invention the scope of the invention is reflected by the breadth of the claims below rather than narrowed by the embodiments described above.

In compliance with the pertinent statutes, the invention has been described in language more or less specific as to structural features, and steps of manufacture, assembly and use. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A beverage holder for use on an aircraft, the beverage holder being configured to withstand inflight turbulence, the beverage holder comprising:
a base frame comprising a U-shaped member on a lower portion of the base frame; a ring pivotably mounted to an upper portion of the base frame; and
a support member and a grip member both pivotably mounted to the lower portion of the base frame, wherein a user orients the ring, the support member and the grip member such that a beverage cup is secured within the ring and the support member, and the grip member is in contact with an aircraft tray.

2. The beverage holder of claim 1, wherein the ring is foldable, and the support member and the grip member fold flat along the base frame.

3. The beverage holder of claim 1, additionally including:
a back clip with an angled hook, the back clip affixed to the upper portion of the base frame; and
the back clip for hanging the beverage holder.

4. A beverage holder device comprising:
a base frame having a U-shaped member on a lower portion of the base frame;
a ring pivotably mounted to an upper portion of the base frame; and
a support member pivotably mounted to the lower portion of the base frame, and a grip member pivotably mounted to the lower portion of the base frame;
the ring pivotable on the upper portion of the base frame to receive a beverage cup, the beverage cup secureable within the ring and the support member; and
the grip member is in contact with a tray.

5. The beverage holder device of claim 4, wherein the tray in contact with the grip member is an aircraft tray.

6. The beverage holder of claim 4, wherein the ring is foldable, and the support member and the grip member fold flat along the base frame.

7. The beverage holder of claim 4, additionally including:
a back clip with an angled hook, the back clip affixed to the upper portion of the base frame; and
the back clip for hanging the beverage holder.

8. A beverage holder device comprising:
a base frame having a lower portion and an upper portion, and a U-shaped member on the lower portion of the base frame;
a ring pivotably mounted to the upper portion of the base frame; and
a support member pivotably mounted to the lower portion of the base frame, and a grip member pivotably mounted to the lower portion of the base frame;
a beverage cup receivable into the ring, the beverage cup having a bottom, the beverage cup secureable within the ring and bottom of the beverage cup supported by the support member; and
the grip member is in contact with a tray, the tray held between the support member and the grip member.

9. The beverage holder device of claim 8, wherein the tray in contact with the grip member is an aircraft tray.

10. The beverage holder of claim 8, additionally wherein the support member and a grip member form a single member, the single member pivotably mounted to the lower portion of the base frame, and the tray held by the single member.

11. The beverage holder of claim 8, wherein the ring is foldable, and the support member and the grip member fold flat along the base frame.

12. The beverage holder of claim 8, additionally including:
a back clip with an angled hook, the back clip affixed to the upper portion of the base frame; and
the back clip for hanging the beverage holder.
